(19) United States
(12) Patent Application Publication
(10) Pub. No.: US 2017/0051539 A1
(43) Pub. Date: Feb. 23, 2017

(54) DRIVE UNIT FOR SECURING AN AXIS-OF-ROTATION DISTANCE OF TRANSMISSION ELEMENTS

(71) Applicant: Kiekert Aktiengesellschaft, Heiligenhaus (DE)

(72) Inventor: Armin HANDKE, Duisburg (DE)

(21) Appl. No.: 15/304,567

(22) PCT Filed: Apr. 16, 2015
(86) PCT No.: PCT/DE2015/000187

§ 371 Date: Nov. 8, 2016

(30) Foreign Application Priority Data
Apr. 17, 2014 (DE) 10 2014 005 656.2

(51) Int. Cl. E05B 81/36; E05B 81/16; E05B 81/24; F16H 19/00

(52) U.S. Cl. CPC E05B 81/36; F16H 19/001; E05B 81/16; E05B 81/25; F16H 2019/008

(57) ABSTRACT

The invention relates to a drive unit (1, 41) for automotive applications, in particular a central locking drive unit for a motor-vehicle door closure, comprising a motor (2, 42) and a transmission unit (3, 43). The transmission unit has at least a first transmission element (4, 44) and a second transmission element (5, 45), which have, respectively, a first tooth segment (6, 46) and a second tooth segment (7, 47) and a first axis of rotation (8, 48) and a second axis of rotation (9, 49). The transmission unit also has a first stop (10, 50). The drive unit has at least a first stop position, and at least the first transmission element (4, 44) has a locking element (11, 51), which is locked in the first stop position by means of an accommodating element (12, 52) and secures a distance (20) of the first axis of rotation (8, 48) of the first transmission element (4, 44) from the second transmission element (5, 45) in the first stop position.

The invention relates to a drive unit for motor vehicular applications, in particular a central locking drive unit for a motor vehicle door latch, with a motor, a gear unit which has at least one first gear element and a second gear element each with a first toothed segment and a second toothed segment and a first rotational axis and a second rotational axis and a first stop, whereby the drive unit has at least a first stop position.

Such a drive unit is known from DE 199 06 997 C2. Such drive units are usually driven by an electromotor. A drive with an electromotor enables it to be ascertained when the drive unit has reached the first stop position by means of detection of the power consumption of the electromotor and to stop the electromotor thereafter. However, a change to the power consumption happens with a certain delay. Consequently, the electromotor cannot be stopped directly upon attainment of the stop position, but a few milliseconds thereafter. During this time very high forces act on the drive unit, in particular on the gear elements, which can allow the toothed segments to overleap. The gear elements become worn and the drive unit can generate noise emissions into the interior of the motor vehicle.

The task of the present invention is therefore to create a drive unit for motor vehicular applications in which an overleap of the gear elements engaging with one another, in particular of the toothed segments, is decreased, the wear and the noise emissions of the gear elements of the drive unit are reduced.

According to the invention, this task is solved by a drive unit with the characteristics of patent claim 1. Advantageous designs with expedient further formations of the invention result from the further patent claims, the description and the figures.

In order to create a drive unit of the type mentioned above, which prevents overleaping, reduces the wear and the noise emissions of the gear elements of the drive unit, it is envisaged according to the invention that at least the first gear element has a locking element which is locked in the first stop position using an attaching element and in the first stop position safeguards a distance of the first rotational axis of the first gear element to the second gear element.

The invention relates in particular to a central locking drive unit for a motor vehicle door latch, whereby the drive unit drives a mechanism to lock and unlock the door latch. From a safety perspective, the drive unit must guarantee perfect functioning of the mechanism for locking and unlocking of the door latch over the entire lifespan. This must be guaranteed in particular if the engagement ratios of the gear elements even only slightly change due to ageing, pollution and wear.

The drive unit has at least one first stop position. The drive unit preferably remains in the first stop position if, for example, a latched closed position of the door latch is present. In another design form, the drive unit remains in the first stop position if an unlocked closed position is present. In particular, a movement of the gear unit is blocked in at least one direction in the first stop position.

According to the invention, in the first stop position the locking element of the first gear element safeguards the distance of the first rotational axis of the first gear element to the second gear element, preferably the distance of the first rotational axis of the first gear element to the second rotational axis of the second gear element. The locking element preferably safeguards the distance of the rotational axes in one direction which is opposite to the direction prescribed by a repulsion of the two gear elements, when the two gear elements with their respective toothed segments are engaged together.

Depending on the arrangement of the first gear element to the second gear element, the locking element in the first stop position safeguards the distance in such a way that an increase of the distance of the rotational axes or a reduction of the distance of the rotational axes to one another is prevented. For example, the locking element can, in an arrangement in which the rotational axes are arranged on respectively opposite sides of a line of contact of the toothed segments engaged with one another, safeguard the distance in such a way that an increase in the distance of the rotational axes is not possible.

In another arrangement in which the rotational axes are arranged on one side viewed respectively from a line of contact of the toothed segments engaged with one another that an increase in the distance of the rotational axes is not possible.

The locking element is bolted in the first stop position by means of the attaching element. As locked is here a firm fit of the locking element to a bearing surface of the second gear element designated. It thus defines the bearing connection between the gear elements. Consequently, an axis distance of the rotational axes of the gear elements is fixed. This locking is distinguished from the state of the door lock which can also assume a bolted and unbolted position, whereby these positions describe a function of the latch, however. For example, the latching element can be designed as a pin which is received in the receiving element in the bolted state.

In particular, the receiving element can have a bearing surface to which the locking element fits in the locked state and forms at least one point of contact with the bearing surface, preferably a line of contact. By means of the bearing surface, the locking element can be supported in such a way that a force acts in a direction of a surface normal of the bearing surface onto the first gear element via a flow of forces from the bearing surface via the locking element to the first gear element. The bearing surface and the locking element can be arranged in such a way that in the locked state a surface normal of the bearing surface intersects the first rotational axis of the first gear element and the point of contact or line of contact. A straight line which intersects the point of contact or line of contact and the first rotational axis preferably includes an angle with the surface normal of the bearing surface which is less than 45 degrees.

In one design, the attaching element has a gap, whereby in a rotational movement of the first gear element the locking element is pushed into the gap in the direction of the first stop position. When the stop position is attained, the locking element preferably abuts an end of the gap. In particular, the gap can narrow at the end. In a further design, the attaching element can have an undercut or a guide to conduct the locking element.

The attaching element can be arranged on a component of the drive unit which is immobile. In an advantageous manner, the component is rigidly connected with at least one bearing element of the second gear element. Consequently, no free play is present between the component and the bearing element. If the drive unit is in the first stop position, the locking element of the attaching element is locked to the component in at least one direction and blocked in the radial direction of the first gear element.

In an especially advantageous design of the invention, it is provided for that the attaching element is arranged on the second gear element and the locking element is blocked in the first stop position by means of the attaching element in the radial direction of the first gear element. In particular, it is provided for that the locking element of the first gear element engages corresponding in such a way with the attaching element of the second gear element that the gear elements are radially against one another fixed in the first stop position.

An advantageous further formation envisages that the first gear element is a gearwheel. In this design form, the first toothed segment of the first gear element extends in particular along a full circumference. A mounting is preferably provided for on the first gear element for the locking element, whereby the mounting can be formed as a disk, for example. The mounting and the first gear element are preferably designed as one component. Advantageously, the locking element is formed as a cylindrical stick, bolt or pin which extends from the mounting in parallel to the first rotational axis of the first gear element. The pin is preferably formed as a single unit with the first gear element.

In a further advantageous further design, it is provided for that the first gear element is driven by a worm and the second gear element is a gearwheel, whereby the second gear element interacts with a lever. The worm is driven by a motor, in particular an electromotor, preferably via a 24-volt power system of a motor vehicle. Such a worm drive causes a strong gear reduction. Consequently, the drive unit can provide a great force, in particular for opening of the door latch. The connection between the first toothed segment and the second toothed segment is preferably also formed as a gear reduction. The second gear element can interact with a lever which preferably changes the state of the setting of the door latch when moving out of the first stop position. The second gear element can drive the lever via a further cogged joint. The lever can impinge directly or indirectly on a locking unit.

In a further design, the second gear element is formed as a lever and the second toothed segment of the second gear element is formed on an external radius of the second gear element. In the arrangement of the second toothed segment on the external radius, in a movement of the drive unit the angular velocities of the first and second gear element have an opposite orientation.

In this design form, a distance from the second toothed segment to the second rotational axis of the second gear element is preferably greater than a distance from the first toothed segment of the first gear element to the first rotational axis of the first gear element, whereby a gear reduction is executed from the first gear element to the second gear element.

An advantageous design of the invention envisages that the toothed segment of the second gear element is formed on an internal radius of the second gear element and overlaps the first toothed segment of the first gear element. In this arrangement, during movement of the drive unit the angle speeds of the first and second gear element have an orientation in the same direction.

In a further formation, the first stop of the drive unit is elastically deformable. As a stopping of the drive unit preferably takes place by means of a capture of a change of the power consumption, very great forces act on the gear elements from the moment on attainment of the first stop position until the stoppage of the drive unit. An elastically deformable first stop can attenuate the high forces and prevent overleaping of the toothed segments in particular. The gear elements are preferably made of plastic. The stops encompass at least an elastic plastic on a side turned towards the gear element.

In a further design, the drive unit has a second stop and a second stop position. In the first stop position the drive unit preferably causes a locking of the door latch and an unlocking of the door latch in the second stop position. In this design form, the first gear element preferably has a second locking element which interacts with a second attaching element of the drive unit in the second stop position and causes locking. Between the first and second stop position the first and second locking element are independent of the bearing surface. In particular, the second attaching element is arranged on the second gear element. In an advantageous further design, several locking elements and corresponding attaching elements can also be provided for, whereby an axis distance securing can also be achieved independently of attainment of a stop position.

Other advantages, characteristics and details of the invention result from the following description of a preferred design example and on the basis of the figures.

These are shown in:

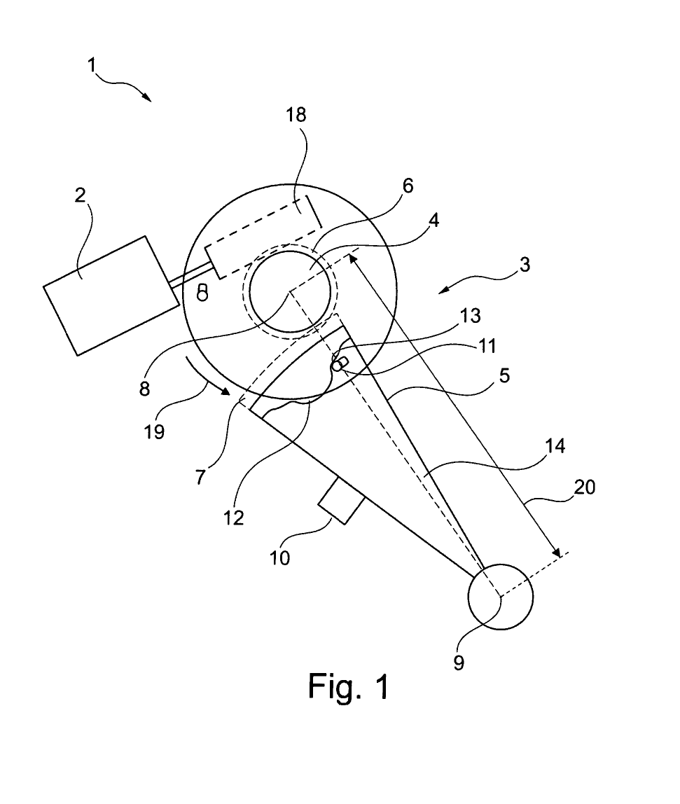

FIG. 1 a drive unit with a first gear element and a second gear element in a first stop position;

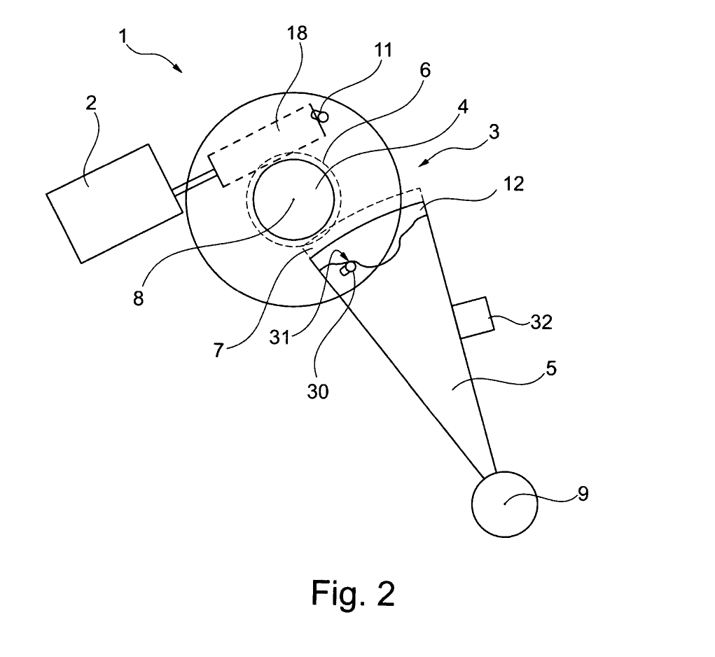

FIG. 2 the same drive unit in a second stop position;

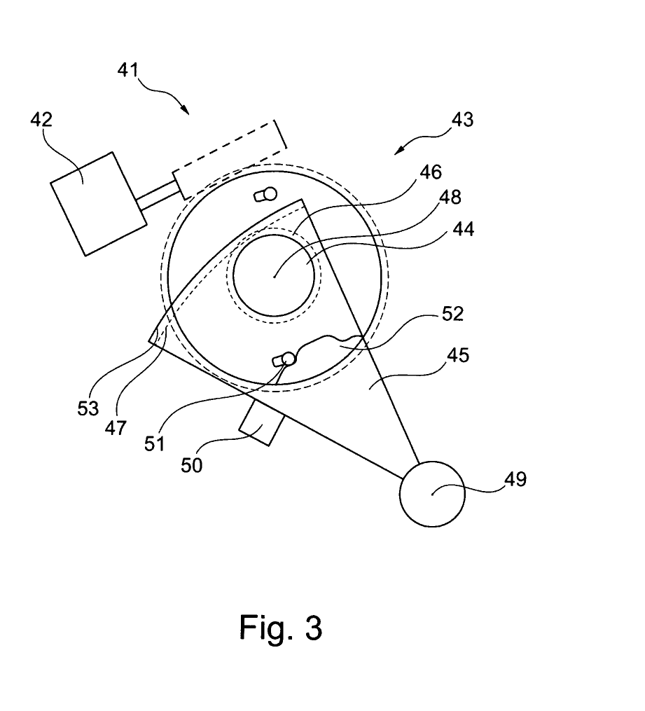

FIG. 3 a drive unit in which a toothed segment of a first gear element overlaps a tooth segment of a second gear element.

FIG. 1 shows a drive unit 1 for a motor vehicle latch with a motor 2, a gear unit 3, which has a first gear element 4 and a second gear element 5 with a first toothed segment 6 and a second toothed segment 7 respectively and a first rotational axis 8 and a second rotational axis 9 and has a first stop 10. The drive unit 1 has a first stop position which is attained when the second gear element 5 comes into contact with the first stop 10. The first stop 10 is elastically deformable. The first gear element 4 has a first locking element 11. Furthermore, the second gear element 5 has an attaching element 12 and can be formed as a single unit with the gear element 5.

In the first stop position, the first locking element 11 is locked by means of the attaching element 12 and safeguards the distance 20 of the first rotational axis 8 to the second rotational axis 9 in such a way that an increase of this distance is prevented by the locking element 11. In the design example shown in FIG. 1 in the first stop position a point of contact of the locking element 11 with a bearing surface 13 lies on a connecting line 14 of the first rotational axis 8 and the second rotational axis 9, whereby the first gear element 4 and the second gear element 5 are radially fixed against one another.

In this first stop position, a closure position of the motor vehicle latch can be controlled using the first gear element 5. It can be imagined, for example, that a locking can be controlled using the gear element 5. In the position of the gear element 5 depicted in FIG. 1 the closed position can then be engaged in a bolted manner, for example. By rotating the motor 2 which is preferably implemented as an electromotor, a worm 18 is driven which engages with the first toothed segment 6. By rotating the worm 18 the first gear element 4 is moved out of the first stop position in a direction 19 towards a second stop position. The first toothed segment 6 and the first gear element 4 are preferably designed as one component.

FIG. 2 shows the same design of the claimed drive unit from FIG. 1 in a second stop position. The second gear element 5, formed as a lever, comes into contact with a second stop 32 of the gear unit 3 which is elastically deformable. The distance of the first rotational axis 8 to the second rotational axis 9 is safeguarded by means of a second locking element 30, which is arranged on the first gear element 4. The second locking element 30 is in particular in contact with a second bearing surface 31 of the attaching element 12. In this design form, the attaching element has a wavy contour. By means of the wavy contour, it is provided for that the first locking element 11 and the second locking element 30 are respectively movable from the first or second stop position of the attaching element 12 and easy and that accurate entry of the locking elements 11, 30 into the bearing surfaces 13, 31 is attained.

In the second stop position a further closed position can be engaged for the lateral door latch of the motor vehicle, as unlocked, for example. The gear element 5 then serves, for example, as a locking element of a central lock. By means of the safeguarding of the distance between the first rotational axis 8 and the second rotational axis 9 the second gear element 5 can in particular be driven out of the first stop position in the direction of the second stop position.

FIG. 3 shows a further design form of a drive unit 41 for a motor vehicle latch with a motor 42, a gear unit 43, which has a first gear element 44 and a second gear element 45 with a first toothed segment 46 and a second toothed segment 47 respectively and a first rotational axis 48 and a second rotational axis 49 and has a first stop 50.

The first gear element 44 has a first locking element 51. Furthermore, the second gear element 45 has an attaching element 52 and is formed as a lever.

In the design form shown in FIG. 3, the toothed segment 47 of the second gear element 45 is formed on an internal radius 53 of the second gear element 45 and overlaps the first toothed segment 46 of the first gear element 44.

FIG. 3 shows the drive unit 41 in a first stop position, whereby the first locking element 51 is locked in the first stop position by means of the attaching element 52 and the distance of the first rotational axis 48 to the second rotational axis 49 is safeguarded in such a way that a decrease of this distance is prevented by the locking element 51.

1. A drive unit for motor vehicular applications, in particular a central locking drive unit for a motor vehicle door latch, with a motor, a gear unit which has at least one first gear element and a second gear element each with a first toothed segment and a second toothed segment and a first rotational axis and a second rotational axis and a first stop, whereby the drive unit has at least a first stop position,
wherein at least the first gear element has a locking element which is locked in the first stop position using an attaching element and in the first stop position safeguards a distance of the first rotational axis of the first gear element to the second gear element.

2. The drive unit according to claim 1,
wherein the attaching element is arranged on the second gear element and the locking element is blocked in the first stop position by means of the attaching element in the radial direction of the first gear element.

3. The drive unit according to claim 1,
wherein the first gear element is a gearwheel.

4. The drive unit according to claim 1,
wherein the first gear element is driven by a worm and the second gear element is a gearwheel, whereby the second gear element interacts with a lever.

5. The drive unit according to claim 1,
wherein the second gear element is formed as a lever and the second toothed segment of the second gear element is formed on an external radius of the second gear element.

6. The drive unit according to claim 1,
wherein the toothed segment of the second gear element is formed on an internal radius of the second gear element and overlaps the first toothed segment of the first gear element.

7. The drive unit according to claim 1,
wherein the first stop is elastically deformable.

8. The drive unit according to claim 1,
wherein the drive unit has a second stop and a second stop position.
